(19) United States
(12) Patent Application Publication
(10) Pub. No.: US 2023/0327110 A1
(43) Pub. Date: Oct. 12, 2023

(54) NON-AQUEOUS ELECTROLYTE SECONDARY BATTERY AND METHOD OF PRODUCING SAME

(71) Applicant: Prime Planet Energy & Solutions, Inc., Tokyo (JP)

(72) Inventors: Naoto ONODERA, Kobe-shi (JP); Hideki SANO, Osaka (JP); Kouhei TSUZUKI, Kobe-shi (JP); Yuki MORIKAWA, Kobe-shi (JP); Yurika KOJIMA, Kobe-shi (JP)

(21) Appl. No.: 18/297,011

(22) Filed: Apr. 7, 2023

(30) Foreign Application Priority Data
Apr. 12, 2022 (JP) 2022-065567

(51) Int. Cl. H01M 4/583; H01M 4/04

(52) U.S. Cl. CPC H01M 4/583; H01M 4/0416; H01M 2004/027

(57) ABSTRACT

A non-aqueous electrolyte secondary battery includes a negative electrode active material layer including a negative electrode active material. The negative electrode active material includes first graphite particles, second graphite particles each having a compressive elastic modulus more than a compressive elastic modulus of each of the first graphite particles, and Si-containing particles. A contact length Lt1 between a first graphite particle and a Si-containing particle is equal to or more than a contact length Lt2 between a second graphite particle and the Si-containing particle.

This nonprovisional application is based on Japanese Patent Application No. 2022-065567 filed on Apr. 12, 2022 with the Japan Patent Office, the entire contents of which are hereby incorporated by reference.

### BACKGROUND OF THE INVENTION

### Field of the Invention

The present invention relates to a non-aqueous electrolyte secondary battery and a method of producing the non-aqueous electrolyte secondary battery.

### Description of the Background Art

It has been known that graphite particles having different diameters are used in a negative electrode active material layer included in a negative electrode of a non-aqueous electrolyte secondary battery (for example, WO 2018/047939, Japanese Patent Laying-Open No. 2016-103347, and the like).

### SUMMARY OF THE INVENTION

When the negative electrode active material layer includes graphite particles and Si-containing particles, the negative electrode including the negative electrode active material layer may be expanded due to internal stress generated during charging and discharging.

It is an object of the present disclosure to provide a non-aqueous electrolyte secondary battery and a method of producing the non-aqueous electrolyte secondary battery so as to suppress expansion of a negative electrode including a negative electrode active material layer.
[1] A non-aqueous electrolyte secondary battery comprising a negative electrode active material layer including a negative electrode active material, wherein
the negative electrode active material includes first graphite particles, second graphite particles each having a compressive elastic modulus more than a compressive elastic modulus of each of the first graphite particles, and Si-containing particles, and
a contact length Lt1 between a first graphite particle and a Si-containing particle is equal to or more than a contact length Lt2 between a second graphite particle and the Si-containing particle.
[2] The non-aqueous electrolyte secondary battery according to [1], wherein in the negative electrode active material layer, a mass-based content of the first graphite particles is less than a mass-based content of the second graphite particles.
[3] The non-aqueous electrolyte secondary battery according to [1] or [2], wherein a content of the first graphite particles with respect to a total amount of the negative electrode active material is 10 mass % or more and 30 mass % or less.
[4] The non-aqueous electrolyte secondary battery according to any one of [1] to [3], wherein a content of the second graphite particles with respect to a total amount of the negative electrode active material is 60 mass % or more and 80 mass % or less.
[5] The non-aqueous electrolyte secondary battery according to any one of [1] to [4], wherein a content of the Si-containing particles with respect to a total amount of the negative electrode active material is 3 mass % or more and 20 mass % or less.
[6] The non-aqueous electrolyte secondary battery according to any one of [1] to [5], wherein an average particle size D50 of the first graphite particles is 0.30 time or more and 0.60 time or less as large as an average particle size D50 of the second graphite particles.
[7] The non-aqueous electrolyte secondary battery according to any one of [1] to [6], wherein an average particle size D50 of the Si-containing particles is 0.15 time or more and 0.30 time or less as large as an average particle size D50 of the second graphite particles.
[8] The non-aqueous electrolyte secondary battery according to any one of [1] to [7], wherein
the Si-containing particles include SiC particles each including a carbon domain and a silicon domain having a size of 50 nm or less, and
a content of oxygen in each of the SiC particles is 7 mass % or less.
[9] A method of producing a non-aqueous electrolyte secondary battery having a negative electrode active material layer, the method comprising:
preparing a slurry including first graphite particles, second graphite particles each having a compressive elastic modulus more than a compressive elastic modulus of each of the first graphite particles, Si-containing particles, and a dispersion medium; and
forming the negative electrode active material layer using the slurry, wherein
the preparing of the slurry includes
   preparing a mixture by mixing the first graphite particles and the Si-containing particles, and
   preparing the slurry using the mixture, the second graphite particles, and the dispersion medium.
[10] The method of producing the non-aqueous electrolyte secondary battery according to [9], wherein the slurry further includes a binder.
[11] The method of producing the non-aqueous electrolyte secondary battery according to [9] or [10], wherein the forming of the negative electrode active material layer includes applying the slurry onto a negative electrode current collector, and drying the applied slurry.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view schematically showing a negative electrode according to an embodiment.

FIG. 2 is a flowchart showing a method of producing a non-aqueous electrolyte secondary battery according to the embodiment.

### DESCRIPTION OF THE PREFERRED EMBODIMENTS

(Non-Aqueous Electrolyte Secondary Battery)

A non-aqueous electrolyte secondary battery (hereinafter, also referred to as “present battery”) according to the present embodiment includes a negative electrode active material layer including a negative electrode active material. The present battery normally has: an electrode assembly having a negative electrode, a positive electrode, and a separator; and an electrolyte solution. The present battery can have an exterior package that accommodates the electrode assembly and the electrolyte solution. When the thickness of the electrode assembly is defined as T and a distance between a pair of side walls of the exterior package (case) is defined as D, T/D is preferably 10 or more and 200 or less, and is more preferably 20 or more and 100 or less. As described later, since expansion of the negative electrode active material layer is suppressed in the present battery, expansion of the electrode assembly can be permitted even when T/D is within the above range. The present battery is preferably a prismatic battery.

The electrode assembly has a structure in which the negative electrode active material layer of the negative electrode and a positive electrode active material layer of the positive electrode are stacked on each other with a separator interposed therebetween. The electrode assembly may be a wound type or a stacked type. The electrode assembly is preferably a flat electrode assembly.

The negative electrode has the negative electrode active material layer formed on a negative electrode current collector. The negative electrode current collector is, for example, a metal foil formed using a copper material such as copper or a copper alloy. For the positive electrode, the separator, and the electrolyte solution, materials known in the field of the present battery can be used.

(Negative Electrode Active Material Layer)

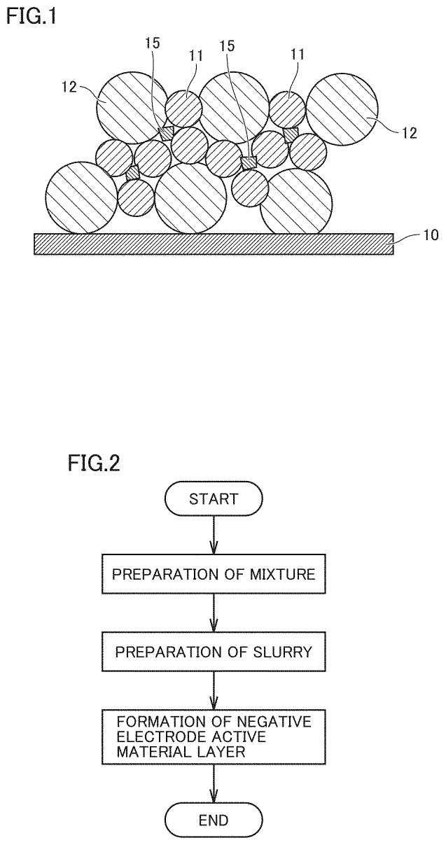

FIG. 1 is a cross sectional view schematically showing the negative electrode according to the embodiment. The negative electrode active material layer is normally formed on negative electrode current collector 10. The negative electrode active material layer includes the negative electrode active material. The negative electrode active material includes: first graphite particles 11; second graphite particles 12 each having a compressive elastic modulus [MPa] more than a compressive elastic modulus [MPa] of each of first graphite particles 11; and Si-containing particles 15. Each of first graphite particles 11 and second graphite particles 12 may have a coating layer on its surface, the coating layer being composed of amorphous carbon. Si-containing particles 15 are particles including silicon atoms.

The compressive elastic modulus [MPa] of each graphite particle (first graphite particle or second graphite particle) is a value obtained by: measuring a compressive stress and a compressive displacement amount when one graphite particle is compressed in a vertical direction; and dividing the compressive stress by a compressive strain (=the compressive displacement amount/an average particle size D50 (described later) of the graphite particles).

The compressive elastic modulus of the first graphite particle is preferably 10 MPa or more and 120 MPa or less, and is more preferably 10 MPa or more and 100 MPa or less. The compressive elastic modulus of the second graphite particle is preferably 140 MPa or more and 250 MPa or less, and is more preferably 160 MPa or more and 250 MPa or less. A difference between the compressive elastic modulus of the first graphite particle and the compressive elastic modulus of the second graphite particle (the compressive elastic modulus of the second graphite particles—the compressive elastic modulus of the first graphite particle) is preferably 20 MPa or more and 240 MPa or less, and is more preferably 60 MPa or more and 240 MPa or less.

In the negative electrode active material layer, a contact length Lt1 between a first graphite particle 11 and a Si-containing particle 15 is equal to or more than a contact length Lt2 between a second graphite particle 12 and Si-containing particle 15. Contact length Lt1 is preferably more than contact length Lt2. Contact lengths Lt1 and Lt2 can be calculated by cross sectional SEM observation on the negative electrode active material layer as follows. A length of a contour portion of one of Si-containing particles 15 measured by the cross sectional SEM observation is defined as La, a total length of contact portion(s) with first graphite particle(s) 11 in length La is defined as Lb1, and a total length of contact portion(s) with second graphite particle(s) 12 in length La is defined as Lb2. Here, when the negative electrode active material layer includes a binder, length Lb1 includes a length of a portion in which Si-containing particle 15 and first graphite particle 11 are in contact with each other with the binder interposed therebetween, and length Lb2 includes a length of a portion in which Si-containing particle 15 and second graphite particle 12 are in contact with each other with the binder interposed therebetween. A ratio Lb1/La of length Lb1 to length La and a ratio Lb2/La of length Lb2 to length La are defined as contact lengths Lt1 and Lt2, respectively. In the negative electrode active material layer, preferably, contact length Lt1 is 0.5 or more and 1.0 or less and contact length Lt2 is 0 or more and 0.5 or less, and more preferably, contact length Lt1 is 0.7 or more and 1.0 or less and contact length Lt2 is 0 or more and 0.3 or less.

When contact lengths Lt1 and Lt2 are within the above ranges in the negative electrode active material layer, the following state is considered to exist: first graphite particles 11 exist around a Si-containing particle 15 and a second graphite particle 12 exists on an outer side with respect to first graphite particles 11 as shown in FIG. 1. Si-containing particles 15 are likely to be expanded and contracted in response to charging and discharging of the present battery to generate internal stress; however, in the present battery, a large amount of first graphite particles 11 exist around Si-containing particles 15. Since each of first graphite particles 11 has a relatively small compressive elastic modulus and is soft, first graphite particle 11 can be deformed to enter a clearance in the negative electrode active material in response to the expansion and contraction of Si-containing particles 15. Thus, the internal stress can be reduced to suppress the expansion of the negative electrode. On the other hand, second graphite particles 12 each having a relatively large compressive elastic modulus are relatively hard, and an amount of expansion thereof in response to charging and discharging of the present battery is small. Since such second graphite particles 12 exist on the outer side with respect to the Si-containing particles 15 and first graphite particles 11, deformation of the negative electrode active material layer can be suppressed to suppress expansion of the negative electrode even when expansion and contraction of Si-containing particles 15 and deformation of first graphite particles 11 occur. Further, when contact lengths Lt1 and Lt2 are within the above-mentioned ranges, adhesion between Si-containing particles 15 and first graphite particles 11 is likely to be maintained and an electric conduction path is less likely to be disconnected, thereby improving capacity retention with respect to charging and discharging of the present battery.

In the negative electrode active material layer, a mass-based content of the first graphite particles is preferably less than a mass-based content of the second graphite particles. The content of the first graphite particles may be 0.1 time or more and 0.6 time or less, 0.2 time or more and 0.6 time or less, or 0.2 time or more and 0.5 time or less as large as the content of the second graphite particles.

The content of first graphite particles 11 with respect to a total amount of the negative electrode active material included in the negative electrode active material layer is preferably 10 mass % or more and 30 mass % or less, and may be 15 mass % or more and 25 mass % or less. The content of second graphite particles 12 with respect to the total amount of the negative electrode active material included in the negative electrode active material layer is preferably 60 mass % or more and 80 mass % or less, and may be 65 mass % or more and 75 mass % or less. A total content of first graphite particles 11 and second graphite particles 12 with respect to the total amount of the negative electrode active material included in the negative electrode active material layer is preferably 80 mass % or more and 97 mass % or less, and may be 90 mass % or more and 95 mass % or less. The content of Si-containing particles 15 with respect to the total amount of the negative electrode active material included in the negative electrode active material layer is preferably 3 mass % or more and 20 mass % or less, and may be 5 mass % or more and 10 mass % or less. When the contents of the respective components of the negative electrode active material in the negative electrode active material layer are within the above ranges, the negative electrode can be further suppressed from being expanded due to charging and discharging of the present battery.

Average particle size D50 (hereinafter, also referred to as “D50”) of first graphite particles 11 may be 0.20 time or more and 0.70 time or less, and is preferably 0.30 time or more and 0.60 time or less as large as D50 of second graphite particles 12. D50 of Si-containing particles 15 may be 0.10 time or more and 0.35 time or less, and is preferably 0.15 time or more and 0.30 time or less as large as D50 of second graphite particles 12. D50 of second graphite particles 12 is preferably 12 μm or more and 30 μm or less, and is more preferably 14 μm or more and 25 μm or less. When D50 of first graphite particles 11, D50 of second graphite particles 12, and D50 of Si-containing particles 15 are within the above ranges, internal stress caused by expansion and contraction of Si-containing particles 15 in the negative electrode active material layer is likely to be reduced, and expansion of the negative electrode is likely to be suppressed. Further, the electric conduction path can be suppressed from being disconnected, thereby further improving the capacity retention. Average particle size D50 in the present specification is a particle size corresponding to a cumulative frequency of 50% from the smallest particle size in a volume-based particle size distribution. The volume-based particle size distribution can be measured by a laser diffraction type particle size distribution measurement apparatus (such as “SALD-2200” manufactured by Shimadzu Corporation).

Examples of Si-containing particles 15 include silicon simple substance particles, SiOx particles, SiC particles (in which silicon nanoparticles are dispersed in porous carbon particles), and the like, and Si-containing particles 15 are preferably the SiC particles. Each of surfaces of Si-containing particles 15 may be coated with amorphous carbon.

Each of the SiC particles preferably includes a carbon domain and a silicon domain having a size of 50 nm or less, and a content of oxygen in each of the SiC particles is preferably 7 mass % or less. Since such SiC particles are included, the SiC particles can be suppressed from being cracked, and battery capacity can be improved because the content of oxygen is small. The oxygen included in each of the SiC particles may be included in the carbon domain, may be included in the silicon domain, or may be included in both the carbon domain and the silicon domain. The size of the silicon domain can be determined from confirmed shape and obtained contrast of the silicon domain in the following manner: the negative electrode active material layer is removed by a focused ion beam (FIB) process and is observed with a transmission electron microscope (TEM) to confirm the elements (Si, C) by energy dispersive X-ray analysis (EDX) mapping, and shape of the silicon domain is confirmed and contrast of the silicon domain is obtained in a high-angle annular dark field image (HAADF image) of a bright field image (BF image). The content of oxygen can be determined by an amount of oxygen extracted using an oxygen analysis apparatus in accordance with a heat melting method in an inert gas. Average particle size D50 of the SiC particles is preferably 2 μm or more and 8 μm or less, and is more preferably 3 μm or more and 5 μm or less. The SiC particles may have pores therein, and preferably has a porosity of 5 volume % or more. Each of the surfaces of the SiC particles may be coated with amorphous carbon.

The negative electrode active material layer can further include a binder and fibrous carbon. Examples of the binder include styrene-butadiene rubber (SBR), carboxymethyl cellulose (CMC), polyacrylic acid (PAA), and the like. Examples of the fibrous carbon include a carbon nanotube (CNT). Since the fibrous carbon is included, the electric conduction path among the components of the negative electrode active material can be likely to be maintained, thereby improving the capacity retention of the present battery.

The content of the SBR is preferably 0.5 mass % or more and 5.0 mass % or less, more preferably 1.0 mass % or more and 3.0 mass % or less, with respect to the total amount of the negative electrode active material layer. The content of the CMC is preferably 0.3 mass % or more and 3.0 mass % or less, more preferably 0.5 mass % or more and 1.5 mass % or less, with respect to the total amount of the negative electrode active material layer. The content of the PAA is preferably 0.5 mass % or more and 5.0 mass % or less, more preferably 1.0 mass % or more and 3.0 mass % or less, with respect to the total amount of the negative electrode active material layer.

The CNT is preferably a carbon nanostructure (SWCNT) in which one layer of carbon hexagonal planes forms one cylindrical shape. The length of the SWNCT can be 0.01 μm or more and 5 μm or less, and the diameter of the SWCNT is preferably 50 nm or less, and more preferably 15 nm or less.

The thickness of the negative electrode active material layer is preferably 100 μm or more and 260 μm or less, and is more preferably 120 μm or more and 200 μm or less.

The packing density of the negative electrode active material layer is preferably 1.20 g/cm³ or more and 1.70 g/cm³ or less, and is more preferably 1.45 g/cm³ or more and 1.65 g/cm³ or less. The porosity of the negative electrode active material layer is preferably 20% or more and 35% or less. The packing density of the negative electrode active material layer can be calculated by dividing a coating weight [g/m²] of the negative electrode active material layer by the thickness of the negative electrode active material layer. The porosity [%] of the negative electrode active material layer can be calculated as follows: {1−(packing density/2.2)}×100.

(Method of Producing Non-Aqueous Electrolyte Secondary Battery) FIG. 2 is a flowchart showing a method of producing the non-aqueous electrolyte secondary battery according to the embodiment. The method of producing the present battery includes: a step of preparing a slurry including first graphite particles, second graphite particles each having a compressive elastic modulus [MPa] more than a compressive elastic modulus [MPa] of each of the first graphite particles, Si-containing particles, and a dispersion medium; and a step of forming a negative electrode active material layer using the prepared slurry. The step of preparing the slurry includes: a step of preparing a mixture by mixing the first graphite particles and the Si-containing particles; and a step of preparing the slurry using the mixture, the second graphite particles, and the dispersion medium.

The step of forming the negative electrode active material layer preferably includes: a step of applying the slurry onto a negative electrode current collector; and a step of drying the applied slurry. The step of forming the negative electrode active material layer can include a step of compressing the dried slurry.

In the method of producing the present battery, the mixture is prepared first, and then the slurry is prepared using the mixture, the second graphite particles, and the dispersion medium, and the negative electrode active material layer is formed using the slurry. Thus, as shown in FIG. 1, the negative electrode active material layer can be formed in which contact length Lt1 is equal to or more than contact length Lt2.

For the first graphite particles, the second graphite particles, and the Si-containing particles, those described with regard to the non-aqueous electrolyte secondary battery can be used. Examples of the dispersion medium included in the slurry include water (ion-exchanged water or the like). The slurry may further include the above-described binder and the above-described fibrous carbon.

A specific surface area BET of the first graphite particles serving as a material used to prepare the slurry may be 1.0 m²/g or more and 5.0 m²/g or less, or may be 2.5 m²/g or more and 4.5 m²/g or less. A specific surface area BET of the second graphite particles serving as a material used to form the slurry is preferably 0.5 m²/g or more and 3.5 m²/g or less, and is more preferably 1.0 m²/g or more and 2.5 m²/g or less. Each of specific surface areas BET is a specific surface area calculated by a multipoint BET method on an adsorption isotherm measured by a gas adsorption method. The second graphite particles having specific surface area BET within the above range can lead to a reduced amount of expansion resulting from charging and discharging of the present battery, and therefore can be said to be hard particles each having a large compressive elastic modulus.

In the step of preparing the mixture, the mixture may be prepared by mixing at least one of a binder, a fibrous carbon, and a dispersion medium in addition to the first graphite particles and the Si-containing particles.

The step of preparing the slurry may be any of the following steps [a] to [d]:
[a] a step of mixing the mixture and the second graphite particles, and introducing them into the dispersion medium;
[b] a step of mixing the mixture, the second graphite particles, and the binder, and introducing them into the dispersion medium;
[c] a step of separately introducing the mixture and the second graphite particles into the dispersion medium; and
[d] a step of mixing a first kneaded body and a second kneaded body, the first kneaded body being obtained by introducing, into a dispersion medium, a material obtained by mixing the mixture and the binder, the second kneaded body being obtained by introducing, into a dispersion medium, a material obtained by mixing the second graphite particles and the binder.

### EXAMPLES

Hereinafter, the present disclosure will be described more specifically with reference to examples and comparative examples.

[Measurement of Compressive Elastic Moduli of First Graphite Particles and Second Graphite Particles]

A Shimadzu microcompression tester MCT-211 is used to measure compressive stress and compressive displacement amount when one graphite particle (first graphite particle or second graphite particle) was compressed in the vertical direction. A value (compression stress/compressive strain) obtained by dividing the compressive stress by a compressive strain (=the compression displacement amount/average particle size D50 of the graphite particles) was calculated. This value was calculated for five graphite particles having the same D50, and the average value thereof was defined as a compressive elastic modulus [MPa] of each graphite particle.

[Measurement of Specific Surface Areas BET of First Graphite Particles and Second Graphite Particles]

A full automatic specific surface area meter Macsorb Model-1201 (using N₂ gas) was used to insert, into a cell, graphite particles (first graphite particles or second graphite particles) each having a predetermined weight for sake of measurement, thereby calculating a specific surface area (BET) per unit weight.

### Example 1

(Preparation of Positive Electrode Plate (Positive Electrode))

A positive electrode composite material was prepared by mixing 1 part by mass of acetylene black (AB) serving as a conductive material and 1 part by mass of polyvinylidene difluoride (PVDF) serving as a binder with respect to 100 parts by mass of lithium-nickel-cobalt-manganese composite oxide (NCM) serving as a positive electrode active material. The positive electrode composite material and N-methyl-2-pyrrolidone (NMP) were mixed to prepare a positive electrode composite material slurry in the form of a paste. The positive electrode composite material slurry was applied onto an aluminum foil (thickness of 15 μm) serving as a positive electrode current collector and was dried, and compression and cutting were performed, thereby obtaining a positive electrode plate.

(Preparation of Negative Electrode Plate (Negative Electrode))

The first graphite particles shown in Table 1 were used as the negative electrode active material, SiC particles (D50: 3 μm) were used as the Si-containing particles, polyacrylic acid (PAA) was used as the binder, and these were dry-mixed to obtain a first mixed powder. SWCNT (water-soluble paste having a solid content of 2 weight %) serving as the fibrous carbon and water serving as the dispersion medium were introduced onto the first mixed powder and kneading was performed, thereby obtaining a first kneaded body.

The second graphite particles shown in Table 1 were used as the negative electrode active material, CMC was used as the binder, and these were dry-mixed, thereby obtaining a second mixed powder. Water serving as the dispersion medium was introduced onto the second mixed powder and kneading was performed, thereby obtaining a second kneaded body.

The first kneaded body and the second kneaded body were mixed, SBR serving as a binder and water were added thereto for dilution and mixing, thereby obtaining a negative electrode composite material slurry (slurry). The negative electrode composite material slurry was prepared using a stirring granulator to attain the following ratio: the first graphite particles: the second graphite particles:SiC:SWCNT:CMC:PAA:SBR=20:70:10:0.5:1:2:2 (weight ratio).

The negative electrode composite material slurry was applied onto a copper foil (thickness of 10 μm) serving as the negative electrode current collector and was dried, and compression was performed to form a negative electrode active material layer, which was then cut to obtain a negative electrode plate. The negative electrode plate was subjected to vacuum drying, and the coating weight of the negative electrode active material layer and the thickness of the negative electrode plate were then measured to be 220 g/m² and 152 μm respectively. The packing density (=coating weight/thickness) of the negative electrode active material layer was 1.55 g/cm³, and the porosity (={1−(packing density/2.2)}×100) was 30%.

(Production of Battery)

A lead was attached to each of the positive electrode plate and the negative electrode plate, and the positive electrode plate and the negative electrode plate were stacked with a separator interposed therebetween, thereby preparing an electrode assembly. The electrode assembly was inserted into an exterior package composed of an aluminum laminate film, an electrolyte solution was injected thereinto, and the opening of the exterior package was sealed, thereby obtaining a battery. As the electrolyte solution, an electrolyte solution was employed which was obtained by dissolving LiPF₆ at a concentration of 1 mol/L in a mixed solvent including ethylene carbonate (EC), ethyl methyl carbonate (EMC) and dimethyl carbonate (DMC) at the following volume ratio:EC:EMC:DMC=20:40:40. A ratio T/D of a distance D between side walls of the exterior package and a thickness T of the electrode assembly was 20.

### Examples 2 to 6 and Comparative Example 1

Each of batteries was produced in the same manner as in example 1 except that the first graphite particles, the second graphite particles, and the Si-containing particles shown in Table 1 were used and the content ratios (mass ratios) thereof were changed to the content ratios shown in Table 1.

[Calculation of Contact Lengths Lt1 and Lt2 in Negative Electrode Active Material Layer]

A length of a contour portion of one Si-containing particle measured by cross sectional SEM observation on the negative electrode active material layer is defined as La, a total length of contact portion(s) with the first graphite particle(s) in length La is defined as Lb1, and a total length of contact portion(s) with the second graphite particle(s) in length La is defined as Lb2. Length Lb1 includes a length of a portion in which the Si-containing particle and the first graphite particle are in contact with each other with the binder interposed therebetween, and length Lb2 includes a length of a portion in which the Si-containing particle and the first graphite particle are in contact with each other with the binder interposed therebetween. A ratio Lb1/La of length Lb1 to length La and a ratio Lb2/La of length Lb2 to length La are defined as contact lengths Lt1 and Lt2, respectively. These were measured for 30 Si-containing particles, and an average value thereof was calculated. Results are shown in Table 1. [Evaluation on Capacity Retention of Battery]

Under an environment of a temperature of 25° C., CCCV charging (charging current of 0.4 C, termination voltage of 4.2 V, and termination current of 0.1 C) and CC discharging (discharging current of 0.4 C, and termination voltage of 2.5 V) for each of the batteries prepared above were performed for one cycle, and a capacity on this occasion was defined as an initial capacity. The CCCV charging and the CC discharging were performed for 300 cycles, and a capacity on this occasion was defined as a capacity after the 300 cycles. A capacity retention was calculated in accordance with the following formula. Results are shown in Table 1.

Capacity retention [%]=(capacity after 300 cycles/initial capacity)×100

[Evaluation on Thickness of Negative Electrode]

The thickness of the negative electrode used in the production of the battery was defined as an initial thickness. The battery having been charged and discharged for the 300 cycles in the evaluation on the capacity retention of the battery was discharged to 2.5 V, and was disassembled in an argon atmosphere to remove the negative electrode. The removed negative electrode was immersed in DMC, cleaned, dried, and measured in thickness, and the thickness was defined as a thickness after the 300 cycles. A ratio of change in the thickness of the negative electrode was calculated in accordance with the following formula. Results are shown in Table 1.

Ratio of change in thickness [%]={(thickness after 300 cycles/initial thickness)−1}×100

TABLE 1

| | | | | | | | Comparative |
|---|---|---|---|---|---|---|---|
| | Example | | | | | | Example |
| | 1 | 2 | 3 | 4 | 5 | 6 | 1 |
| First Graphite | | | | | | | |
| Particles | | | | | | | |
| Compressive | 60 | 100 | 60 | 60 | 80 | 60 | 160 |
| Elastic Modulus | | | | | | | |
| [MPa] | | | | | | | |
| D50 [μm] | 10 | 11 | 10 | 10 | 22 | 10 | 10 |
| BET [m²/g] | 4.0 | 3.8 | 4.0 | 4.0 | 3.2 | 4.0 | 2.1 |
| Second Graphite | | | | | | | |
| Particles | | | | | | | |
| Compressive | 180 | 160 | 180 | 180 | 160 | 180 | 80 |
| Elastic Modulus | | | | | | | |
| [MPa] | | | | | | | |
| D50 [μum] | 20 | 22 | 20 | 20 | 10 | 20 | 22 |
| BET [m²/g] | 1.2 | 1.5 | 1.2 | 1.2 | 2.1 | 1.2 | 3.2 |
| Graphite Particles | | | | | | | |
| Difference | 120 | 60 | 120 | 120 | 80 | 120 | −80 |
| between | | | | | | | |
| Compressive | | | | | | | |
| Elastic Moduli*¹ | | | | | | | |
| Ratio of D50*² | 0.50 | 0.50 | 0.50 | 0.50 | 2.20 | 0.50 | 0.45 |
| Si-Containing | | | | | | | |
| Particles | | | | | | | |
| D50 [μm] | 3 | 3 | 3 | 3 | 3 | 3 | 3 |
| Negative Electrode | | | | | | | |
| Active Material | | | | | | | |
| Layer | | | | | | | |
| Relation between | Lt1 > Lt2 | Lt1 > Lt2 | Lt1 > Lt2 | Lt1 > Lt2 | Lt1 > Lt2 | Lt1 = Lt2 | Lt1 > Lt2 |
| Contact Lengths | | | | | | | |
| Content Ratio | 20:70:10 | 20:70:10 | 25:65:10 | 15:75:10 | 20:70:10 | 45:45:10 | 20:70:10 |
| (Mass Ratio)*³ | | | | | | | |
| Evaluation on | | | | | | | |
| Battery | | | | | | | |
| Capacity | 90 | 88 | 87 | 91 | 81 | 85 | 76 |
| Retention [%] | | | | | | | |
| Ratio of Change in | 23 | 25 | 21 | 20 | 35 | 33 | 46 |
| Thickness [%] | | | | | | | |

*¹The difference between compressive elastic moduli [MPa] represents “Compressive Elastic Modulus of Second Graphite Particles − Compressive Elastic Modulus of First Graphite Particles”.
*²The ratio of D50 represents “50 of First Graphite Particles/D50 of Second Graphite Particles”.
*³The numerical value of the content ratio (mass ratio) represents “First Graphite Particles:Second Graphite Particles:Si-Containing Particles”.

In comparative example 1, the compressive elastic modulus of the first graphite particle is more than the compressive elastic modulus of the second graphite particle. Therefore, since the graphite particles each having a large compressive elastic modulus were disposed around the Si-containing particles and the graphite particles each having a small compressive elastic modulus were disposed on the outer side with respect to the graphite particles each having a large compressive elastic modulus, it is considered that the ratio of change in the thickness became large. Further, in comparative example 1, it is considered that the electric conduction path was disconnected by the charging and discharging, thus resulting in decreased capacity retention. On the other hand, in each of examples 1 to 6, since the graphite particles each having a small compressive elastic modulus are disposed around the Si-containing particles and the graphite particles each having a large compressive elastic modulus are disposed on the outer side with respect to the graphite particles each having a small compressive elastic modulus, it is considered that the ratio of change in the thickness and the capacity retention are excellent. In view of the comparison between example 1 and example 5, it is understood that the ratio of change in the thickness and the capacity retention can be more improved when D50 of the first graphite particles is relatively small. In view of the comparison between example 1 and example 6, it is understood that the ratio of change in the thickness can be more improved when the content of the first graphite particles is relatively small.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A non-aqueous electrolyte secondary battery comprising a negative electrode active material layer including a negative electrode active material, wherein
the negative electrode active material includes first graphite particles, second graphite particles each having a compressive elastic modulus more than a compressive elastic modulus of each of the first graphite particles, and Si-containing particles, and
a contact length Lt1 between a first graphite particle and a Si-containing particle is equal to or more than a contact length Lt2 between a second graphite particle and the Si-containing particle.

2. The non-aqueous electrolyte secondary battery according to claim 1, wherein in the negative electrode active material layer, a mass-based content of the first graphite particles is less than a mass-based content of the second graphite particles.

3. The non-aqueous electrolyte secondary battery according to claim 1, wherein a content of the first graphite particles with respect to a total amount of the negative electrode active material is 10 mass % or more and 30 mass % or less.

4. The non-aqueous electrolyte secondary battery according to claim 1, wherein a content of the second graphite particles with respect to a total amount of the negative electrode active material is 60 mass % or more and 80 mass % or less.

5. The non-aqueous electrolyte secondary battery according to claim 1, wherein a content of the Si-containing particles with respect to a total amount of the negative electrode active material is 3 mass % or more and 20 mass % or less.

6. The non-aqueous electrolyte secondary battery according to claim 1, wherein an average particle size D50 of the first graphite particles is 0.30 time or more and 0.60 time or less as large as an average particle size D50 of the second graphite particles.

7. The non-aqueous electrolyte secondary battery according to claim 1, wherein an average particle size D50 of the Si-containing particles is 0.15 time or more and 0.30 time or less as large as an average particle size D50 of the second graphite particles.

8. The non-aqueous electrolyte secondary battery according to claim 1, wherein
the Si-containing particles include SiC particles each including a carbon domain and a silicon domain having a size of 50 nm or less, and
a content of oxygen in each of the SiC particles is 7 mass % or less.

9. A method of producing a non-aqueous electrolyte secondary battery having a negative electrode active material layer, the method comprising:
preparing a slurry including first graphite particles, second graphite particles each having a compressive elastic modulus more than a compressive elastic modulus of each of the first graphite particles, Si-containing particles, and a dispersion medium; and
forming the negative electrode active material layer using the slurry, wherein
the preparing of the slurry includes
preparing a mixture by mixing the first graphite particles and the Si-containing particles, and
preparing the slurry using the mixture, the second graphite particles, and the dispersion medium.

10. The method of producing the non-aqueous electrolyte secondary battery according to claim 9, wherein the slurry further includes a binder.

11. The method of producing the non-aqueous electrolyte secondary battery according to claim 9, wherein the forming of the negative electrode active material layer includes applying the slurry onto a negative electrode current collector, and drying the applied slurry.
